(19) United States
(12) Patent Application Publication
(10) Pub. No.: US 2015/0225580 A1
(43) Pub. Date: Aug. 13, 2015

(54) PROCESS FOR PRODUCTION OF ROSIN RESIN, PRODUCT OBTAINED BY SAID PROCESS AND USE THEREOF

(71) Applicant: EURO YSER-PRODUTOS QUÍMICOS, S.A., Aveiro, PT (PT)

(72) Inventors: Davide Marques Gameiro, Abiul (PT); Jorge Fernando Jordão Coelho, Coimbra (PT); João Pedro Cesário Serrano, S. Bernardo - Aveiro (PT); Nadia Carina Silva Costa Rocha, Aveiro (PT)

(21) Appl. No.: 14/421,528

(22) PCT Filed: Jul. 12, 2013
(86) PCT No.: PCT/PT2013/000043

§ 371 Date: Feb. 13, 2015

(30) Foreign Application Priority Data
Aug. 13, 2012 (PT) 106499

(51) Int. Cl. C09D 11/107; C09D 11/08

(52) U.S. Cl. CPC C09D 11/107; C09D 11/08

(57) ABSTRACT

The present invention relates to a process for production of rosin resin, comprising the reaction between rosin, an acrylic copolymer and a divalent metal selected from the group consisting of calcium, zinc and magnesium, further comprising an additional esterification step with a polyol. The present invention further relates to the use of rosin resin of the present invention as binder in the preparation of inks.

### FIELD OF THE INVENTION

The present invention relates to a process for production of a rosin resin, comprising the reaction between rosin, an acrylic copolymer and a divalent metal, further comprising an additional esterification step with a polyol and its use as binder in ink preparation.

### BACKGROUND OF THE INVENTION

Rosin is obtained from conifers and pines, being the solid residue resulting from the distillation operation of fresh liquid resin, after separation and collection of volatile liquid terpenes.

It is solid with an amber type appearance, having a variable color between yellow and brown depending on the extraction conditions and temperature of the distillation operation above mentioned.

Rosin consists of a mixture of di or tri-unsaturated monoacids, with twenty carbon atoms, having a central core formed with three adjacent rings of six carbon atoms each.

The acids that make up rosin belong to two basic classes:
abietic, that include, in addition to abietic acid, neoabietic, palustric, levopimaric and dehydroabietic acids;
pimaric, that include pimaric, isopimaric and sandaracopimaric acid.

From the first of the above mentioned classes, the abietic, neoabietic, palustric and levopimaric acids differ from each other only in the position of their two double bonds. The dehydroabietic acid is the only one that has three double bonds. All double bonds are endocyclic except in neoabietic acid which has an exocyclic double bond.

Pimaric and sandaracopimaric acid differ from each other in the configuration of the carbon atom to which a methyl group and ethenyl group are linked. Isopimaric acid and sandaracopimaric acid differ in the position of the endocyclic double bond.

This group of molecules shows low stability due to existence of conjugated double bonds, but its stability can be improved through chemical reactions that modify its structure, such as, for example, hydrogenation.

Currently, almost all resins used in graphic ink for rotogravure and offset are based in modified rosin with one or more simultaneous or successive reactions with dienophile and/or a phenol/formaldehyde resin, followed by esterification with a polyol. By changing the relative amounts of the starting materials and/or procedure, one can obtain a whole range of resins adapted to different technical-economic conditions in the formulation of graphic ink.

A disadvantage of the above described process is related with the fact that formaldehyde is a toxic substance and the majority of the used phenols are alkylphenol-type which are classified as endocrine disruptors. Therefore, the risk of contacting this type of substances exists.

Patent application JP 2000159867 (A), entitled “Resin for printing ink”, relates to a resin prepared by reacting rosin with dienophile (for example, maleic anhydride) and a polyol (for example, glycerol or pentaerythritol), the reaction being carried out at 230 -290° C. for 5 to 15 hours, in the presence of catalyst selected from MgO, ZnO or CaO and optionally an antifoam agent.

U.S. Pat. No. 5,814,701 (A) entitled “Process for the production of water soluble modified rosin ester vehicles for laminating inks”, relates to an esterification process with a polyol from the reaction product between rosin and at least a carboxylated dienophile, followed by reaction of the obtained product with an acrylic copolymer between 175 and 185° C. for 15 to 45 minutes, to produce a binder with adequate properties.

U.S. Pat. No. 5,180,774 (A), entitled “Modified rosin esters and their use in printing inks”, relates to a binder comprising a rosin ester prepared by a process in two steps:
in the first step, an adduct is formed between rosin and a dienophile, said adduct is reacted with a polyol to form an ester, which is then reacted with an acrylic polymer to form a hardened rosin ester;
in the second step, the product of the previous step is reacted with an adduct (formed by reaction between rosin and a dienophile) and an acrylic polymer, the resultant product of this reaction is first reacted with a zinc compound (metal zinc, zinc oxide or hydroxide) and then with calcium hydroxide.

The above described processes, although not using phenolic compounds, include, in an optional manner, a first step for formation of an adduct by a Diels-Alder reaction between rosin acids and a dienophile such as, for example, fumaric acid or maleic anhydride.

All the products of prior art show great problems to the user, such as the incapacity to keep a high viscosity in diluted solutions and the viscosity of its solutions are in general very unstable, usually increasing with shelf life.

Surprisingly, the process of the present invention provides a product (a rosin resin) which although being a hard resin, as adequate for printing ink, allows for high viscosities in diluted solutions, produces solutions which properties are stable with time and also with high mechanical resilience, allowing printings with high resistance to abrasion.

### SUMMARY OF THE INVENTION

The present invention relates to a process for production of rosin resin comprising the steps of:
a) heating with agitation previously melted rosin to a temperature in the range of 200 to 260° C. and adding an acrylic copolymer; and
b) adding a source of divalent metal and allowing to react at a temperature in the range of 200 to 260° C. until a constant viscosity transparent resin is obtained.

In a preferred embodiment, step a) is carried out at a temperature in the range of 200 to 230° C., and step b) is carried out at a temperature in the range of 230 to 260° C.

In one aspect of the present invention, the process further comprises an additional esterification step of the product obtained in step b) with a polyol at a temperature in the range of 200 to 260° C., until a constant viscosity transparent resin is obtained.

In other aspect of the present invention, the acrylic copolymer comprises an element selected from the group consisting of acrylic acid, esters derived from acrylic acid, methacrylic acid, esters derived from methacrylic acid, hydroxyalkyl acrylates, hydroxyalkyl methacrylates and mixtures thereof and another element selected from the group consisting of styrene, alpha-methyl styrene, ethylene, ethylene and vinyl acetate copolymer and combinations thereof.

In one embodiment, the copolymer is a styrene and methyl methacrylate copolymer.

In other embodiment, the acrylic copolymer to rosin ratio is comprised between 0.2:1 and 1.5:1.

In a preferred embodiment, the acrylic copolymer to rosin ratio is comprised between 0.5:1 and 1.2:1.

In other aspect of the present invention, the divalent metal source is selected from the group consisting of calcium, zinc, magnesium compounds and combinations thereof.

In one embodiment, the divalent metal source is selected from the group consisting of calcium oxide, calcium hydroxide, calcium acetate, zinc oxide, zinc hydroxide, magnesium oxide and combinations thereof.

In a preferred embodiment, the divalent metal source consists of mixture of zinc oxide in a ratio to rosin of 0.01:1 to 0.1:1 and calcium acetate in a ratio to rosin of 0.005:1 to 0.1:1.

In yet another aspect of the present invention, polyol is selected from the group consisting of glycerol, pentaerythritol, trimethylolethane, trimethylolpropane, neopentyl glycol, cyclohexanedimethanol and mixtures thereof.

In one embodiment, the polyol to rosin ratio is comprised between 0.02:1 and 0.5:1.

In a preferred embodiment, the process comprises the steps of:
a) heating with agitation previously melted rosin at a temperature of 200° C. and then adding a styrene and methyl methacrylate copolymer in a ratio to
b) heating the previous mixture at 250° C., then adding zinc oxide in a ratio to rosin of 0.062:1, calcium acetate in a ratio to rosin of 0.024:1 and allowing the mixture to react at a temperature of 250° C. until a transparent resin is obtained; and
c) adding glycerol in a ratio to rosin of 0, 114:1 and allowing to react at a temperature of 250° C., until a constant viscosity is obtained which corresponds to a minimum flow time of 9 s in the DIN 6 cup.

The process of the present invention provides a rosin resin for use as binder in the preparation of graphic inks.

### DETAILED DESCRIPTION OF THE INVENTION

The present invention relates to a process for production of rosin resin that acts as binder in the preparation of inks.

Viscosity is the most important parameter for characterization of the resin obtained via the process of the present invention.

Viscosity can be readily measured by a comparative method that consists of measuring the flow time of a given liquid volume through an orifice of known diameter. The measuring unit of this flow time is second.

In practice, a cylindrical container with a known volume and an orifice of determined diameter and located in the center of the base is used. The container is totally filled with the liquid which viscosity is to be determined and the time from the start of the flow until the first interruption of the flow is measured. From the available measuring instruments, Ford, DIN or GS cups are commonly used for this purpose.

In the present description, the rosin resin is characterized by measuring the flow time, in seconds, of a 30% solids solution in toluene at a temperature of 22° C. in DIN 6 cup (where the orifice diameter is 6 mm).

Another parameter used for the characterization of rosin resin is the dilution rate.

In the present description, the dilution rate expressed in percentage, is numerically equal to the solvent weight (toluene) which is necessary to add to 100 grams of resin solution at 30% solids in toluene, to obtain a viscosity corresponding to a flow time of 30 seconds in a GS cup where the orifice diameter is 3 mm.

Another usually evaluated parameter in this industry is the color of a resin solution in a given solvent.

The color is measured using the Gardner Scale, a visual scale described in the ASTM D1544 Standard (Standard Test Method for Color of Transparent Liquids (Gardner Color Scale)), with 18 levels, wherein level 1 represents a very pale yellow and level 18 represents brownish red. By visual comparison of the color of the resin solution with a pre-set scale, a 1 to 18 color level is attributed to the color of the solution.

In the present description, the color of a solution of 50% solids in toluene is measured.

The rosin used in the present invention can be obtained from live pines, making incisions on the tree and collecting the exudate in a container placed on the tree trunk, then distilling the volatile components to obtain rosin, which is the solid residue of this process.

The rosin can also be obtained from previously cut pine trunks; the trunks are reduced to wood chips, immersed in a solvent that extracts fatty acids and turpentine, in addition to rosin. The rosin obtained from this process is so-called wood rosin.

Another source of rosin is tall oil resin obtained by distillation of “tall oil”, a by-product obtained in a soap form of wood alkaline extraction during the Kraft process.

In the present description, the term “rosin” means the product obtained for any of the above mentioned processes.

Independently of the explicit presence of a quantitative term “about X”, any X value shown in the present description must be interpreted as an approximate value of the actual X value, as such approximation from the actual value would be reasonably expected by the skilled in the art due to experimental and/or measuring conditions that introduce deviations from the actual value.

Unless indicated otherwise, percentages used in the present description refer to weight percentages.

The present invention relates to a process for production of a rosin resin, comprising the steps of:
a) heating with agitation previously melted rosin to a temperature in the range of 200 to 260° C. and adding an acrylic copolymer; and
b) adding a source of divalent metal and allowing to react at a temperature in the range of 200 to 260° C. until a constant viscosity transparent resin is obtained.

In a preferred embodiment, step a) is carried out at a temperature in the range of 200 to 230° C. and step b) is carried out at a temperature in the range of 230 to 260° C.

The acrylic copolymer used in the process of the present invention comprises an element selected from the group consisting of acrylic acid, esters derived from acrylic acid, methacrylic acid, esters derived from methacrylic acid, hydroxyalkyl acrylates, hydroxyalkyl methacrylates and mixtures thereof and another element selected from the group consisting of styrene, alpha-methyl styrene, ethylene, ethylene and vinyl acetate copolymer and combinations thereof.

Preferably, the used copolymer is a styrene and methyl methacrylate copolymer commercially available from INEOS NOVA under the trade name NAS® 30.

The acrylic copolymer is used in the process of the present invention in a weight ratio to rosin from 0.2:1 to 1.5:1, preferably, in a ratio from 0.5:1 to 1.2:1.

The reaction between the acrylic copolymer and rosin is carried out in the presence of a divalent metal source.

The divalent metal source is selected from the group consisting of compounds of calcium, zinc and magnesium and combinations thereof. Preferably, the divalent metal source is selected from the group consisting of calcium oxide, calcium hydroxide, calcium acetate, zinc oxide, zinc hydroxide, magnesium oxide and combinations thereof.

In one embodiment, the reaction can be carried out in the presence of a zinc oxide mixture, in a ratio to rosin comprised between 0.01:1 and 0.1:1 and calcium acetate in a ratio to rosin comprised between 0.005:1 and 0.1:1.

Preferably, the reaction can be carried out in the presence of a zinc oxide mixture, in a ratio to rosin of 0.01:1 and calcium acetate in a ratio to rosin of 0.007:1.

In another embodiment, the reaction can be carried out in the presence of a zinc oxide mixture, in a ratio to rosin comprised between 0.01:1 and 0.1:1 and magnesium oxide in a ratio to rosin comprised between 0.005:1 and 0.03:1.

The process according to the present invention can further comprise an additional esterification step with a polyol added immediately after step b), wherein the reaction occurs at a temperature in the range of 200° C. to 260° C.

The polyol used in the process of the present invention is selected from glycerol, pentaerythritol, trimethylolethane, trimethylolpropane, neopentyl glycol, cyclohexanedimethanol or other similar polyols and combinations thereof, and the polyol to rosin ratio is comprised between 0.02:1 and 0.5:1.

The rosin resins obtained according to the process of the present invention are characterized by a low viscosity (flow time 9 to 40 s) and by a dilution rate of at least 150%.

Although the process of the present invention does not include a first reaction step between rosin and a dienophile, which is an advantage as allows to reduce the running time, the resultant product shows improved characteristics in view of the prior art (see Example 9), demonstrating that it is particularly adequate to be used as binder in the production of ink, because:
it allows to obtain high viscosities in diluted solutions, a property that is particularly useful in rotogravure graphic ink;
it allows to obtain stable solutions, which properties are kept unchanged after even long time periods, which is a very important characteristic in the user's point of view;
shows high mechanical resilience, allowing printings of high resistance to abrasion.

For a better understanding of the invention, it is hereinafter described, for illustration purposes and not by limitation, examples of application of the process of the present invention.

### EXAMPLES

### Example 1

### Production of a Rosin Resin for Rotogravure Printing Ink

In a reactor inertized with nitrogen atmosphere, equipped with temperature sensor, heating jacket, reflux condenser and stirrer, 1500 parts of rosin were melted at a temperature of 180° C. and after fusing rosin was heated with agitation at a temperature of 200° C.

1500 parts of a styrene and methyl methacrylate copolymer (NAS® 30, commercially available from INEOS NOVA) were added for 60 minutes, the mixture was heated up to 250° C., 15 parts of zinc oxide and 10 parts of calcium acetate were added.

It was left reacting at a temperature of 250° C. until constant viscosity, which should at least correspond to a minimum flow time of 9 s in DIN 6 cup.

The product thus obtained showed the following properties
Color (Gardner Scale): 9;
Viscosity: 10 s;
Dilution rate: 156%, corresponding to the addition of 180 mL of toluene to 100 g of resin solution at 30% of solids, in order to obtain a flow time of 30 seconds in GS 3 mm cup, at a temperature of 22° C.

### Example 2

In a reactor inertized with nitrogen atmosphere, equipped with temperature sensor, heating jacket, reflux condenser and stirrer, 1500 parts of rosin were melted at a temperature of 180° C. and then rosin was heated with agitation at a temperature of 200° C.

1000 parts of a styrene and methyl methacrylate copolymer (NAS® 30, commercially available from INEOS NOVA) were added for 60 minutes, the mixture was heated up to 250° C., 130 parts of zinc oxide and 50 parts of calcium acetate were added.

It was left reacting at a temperature of 250° C. until the reactor content was transparent after cooling down to room temperature (carried out upon removing a sample from the reactor).

Then, 50 parts of pentaerythritol were added and the reactor content was esterified at a temperature of 250° C. until constant viscosity, which should at least correspond to a flow time of 9 s in DIN 6 cup.

The product obtained showed the following properties:
Color (Gardner Scale): 9;
Viscosity: 12 s;
Dilution rate: 173%.

### Example 3

In a reactor inertized with nitrogen atmosphere, equipped with temperature sensor, heating jacket, reflux condenser and stirrer, 1500 parts of rosin were melted at a temperature of 180° C. and then rosin was heated with agitation at a temperature of 200° C.

1690 parts of styrene and methyl methacrylate copolymer (NAS® 30, commercially available from INEOS NOVA) were added for 60 minutes, the mixture was heated up to 250° C., 15 parts of zinc oxide and 10 parts of calcium acetate were added.

It was left reacting at a temperature of 250° C. until constant viscosity which should at least correspond to a minimum flow time of 9 s in DIN 6 cup.

The product obtained showed the following properties:
Color (Gardner Scale): 9;
Viscosity: 12 s;
Dilution rate: 167%.

### Example 4

In a reactor inertized with nitrogen atmosphere, equipped with temperature sensor, heating jacket, reflux condenser and stirrer, 1800 parts of rosin were melted at a temperature of 180° C. and then rosin was heated with agitation at a temperature of 200° C.

1200 parts of a styrene and methyl methacrylate copolymer (NAS® 30, commercially available from INEOS NOVA) were added for 60 minutes, the mixture was heated up to 250° C., 130 parts of zinc oxide and 50 parts of calcium acetate were added.

It was left reacting at a temperature of 250° C. until the reactor content was transparent after cooling down to room temperature (carried out upon removing a sample from the reactor).

Then, 90 parts of glycerin were added and the reactor content was esterified at a temperature of 250° C. until constant viscosity, which should at least correspond to a flow time of 9 s in DIN 6 cup.

The product obtained showed the following properties:
Color (Gardner Scale): 9;
Viscosity: 15 s;
Dilution rate: 203%.

### Example 5

In a reactor inertized with nitrogen atmosphere, equipped with temperature sensor, heating jacket, reflux condenser and stirrer, 2100 parts of rosin were melted at a temperature of 180° C. and then rosin was heated with agitation at a temperature of 200° C.

900 parts of a styrene and methyl methacrylate copolymer (NAS® 30, commercially available from INEOS NOVA) were added for 60 minutes, the mixture was heated up to 250° C., 130 parts of zinc oxide and 50 parts of calcium acetate were added.

It was left reacting at a temperature of 250° C. until the reactor content was transparent after cooling down to room temperature (carried out upon removing a sample from the reactor).

Then, 240 parts of glycerin were added and the reactor content was esterified at a temperature of 250° C. until constant viscosity, which should at least correspond to a flow time of 9 s in DIN 6 cup.

The product obtained showed the following properties:
Color (Gardner Scale): 9;
Viscosity: 13 s;
Dilution rate: 172%.

### Example 6

In a reactor inertized with nitrogen atmosphere, equipped with temperature sensor, heating jacket, reflux condenser and stirrer, 1800 parts of rosin were melted at a temperature of 180° C. and then rosin was heated with agitation at a temperature of 200° C.

1200 parts of a styrene and methyl methacrylate copolymer (NAS® 30, commercially available from INEOS NOVA) were added for 60 minutes, the mixture was heated up to 250° C., 130 parts of zinc oxide and 50 parts of calcium acetate were added.

It was left reacting at a temperature of 250° C. until the reactor content was transparent after cooling down to room temperature (carried out upon removing a sample from the reactor).

Then, 90 parts of trimethylolethane were added and the reactor content was esterified at a temperature of 250° C. until constant viscosity, which should at least correspond to a flow time of 9 s in DIN 6 cup.

The product obtained showed the following properties:
Color (Gardner Scale): 9;
Viscosity: 15 s;
Dilution rate: 203%.

### Example 7

In a reactor inertized with nitrogen atmosphere, equipped with temperature sensor, heating jacket, reflux condenser and stirrer, 1800 parts of rosin were melted at a temperature of 180° C. and then rosin was heated with agitation at a temperature of 200° C.

900 parts of an ethylene and methyl methacrylate copolymer were added for 60 minutes, the mixture was heated up to 250° C., 130 parts of zinc oxide and 50 parts of calcium acetate were added.

It was left reacting at a temperature of 250° C. until the reactor content was transparent after cooling down to room temperature (carried out upon removing a sample from the reactor).

Then, 90 parts of trimethylolethane were added and the reactor content was esterified at a temperature of 250° C. until constant viscosity, which should at least correspond to a flow time of 9 s in DIN 6 cup.

The product obtained shows the following properties:
Color (Gardner Scale): 9;
Viscosity: 10 s;
Dilution rate: 180%.

### Example 8

In a reactor inertized with nitrogen atmosphere, equipped with temperature sensor, heating jacket, reflux condenser and stirrer, 1800 parts of rosin were melted at a temperature of 180° C. and then rosin was heated with agitation at a temperature of 200° C.

1200 parts of a styrene and methyl methacrylate copolymer (NAS® 30, commercially available from INEOS NOVA) were added for 60 minutes, the mixture was heated up to 250° C., 130 parts of zinc oxide and 13 parts of magnesium oxide were added.

The ° C. is left reacting at a temperature of 250 until the reactor content was transparent after cooling down to room temperature (carried out upon removing a sample from the reactor).

Then, 90 parts of trimethylolethane were added and the reactor content was esterified at a temperature of 250° C. until constant viscosity, which should at least correspond to a flow time of 9 s in DIN 6 cup.

The product obtained shows the following properties:
Color (Gardner Scale): 9;
Viscosity: 13 s;
Dilution rate: 170%.

### Example 9

To analyze the stability of the properties of the resin with time and at room temperature, comparative analyses between a varnish produced from the resin obtained according to Example 1 (designated example 1 in the following table) and a commercially available product (designated commercial Varnish in the following table) were carried out.

For each of the products, the viscosity of the solution was measured with time, in the conditions referred to in examples 1 to 6 (designated pDIN6 in the following table) and the dilution rate was calculated, as refereed to in examples 1 to 8.

| | μDIN6 (s) | | Dilution Rate (%) | |
|---|---|---|---|---|
| Time | Commercial | | Commercial | |
| (days) | varnish | Example 1 | varnish | Example 1 |
| 0 | 53 | 10 | 126 | 156 |
| 8 | 72 | 11 | 139 | 155 |
| 15 | 290 | 10 | 160 | 157 |

It can be seen that the varnish produced from the resin obtained according to example 1 keeps its viscosity with time, whereas 15 days are enough to observe a significant increase in the viscosity of the commercially available varnish.

The dilution rate shows a similar variation, as in the case of the prior art product it is necessary to add increasing volumes of solvent to keep a certain viscosity, whereas the dilution rate of the product obtained according to example 1 is constant, showing the stability with time of the properties of the product.

1. A process for production of rosin resin comprising the steps of:
a) heating with agitation previously melted rosin to a temperature in the range of 200 to 260° C. and adding an acrylic copolymer; and
b) adding a source of divalent metal and allowing to react at a temperature in the range of 200 to 260° C. until a constant viscosity transparent resin is obtained.

2. The process according to claim 1, wherein
step a) is carried out at a temperature in the range of 200 to 230° C.; and,
step b) is carried out at a temperature in the range of 230 to 260° C.

3. The process according to claim 1, further comprising an additional esterification step of the product obtained in step b) with a polyol at a temperature in the range of 200° C. to 260° C., until constant viscosity transparent resin is obtained.

4. The process according to claim 1, wherein the acrylic copolymer comprises an element selected from the group consisting of acrylic acid, esters derived from acrylic acid, methacrylic acid, esters derived from methacrylic acid, hydroxyalkyl acrylates, hydroxyalkyl methacrylates and mixtures thereof and another element selected from the group consisting of styrene, alpha-methyl styrene, ethylene, ethylene and vinyl acetate copolymer and combinations thereof.

5. The process according to claim 4, wherein the copolymer is a styrene and methyl methacrylate copolymer.

6. The process according to claim 1, wherein the ratio of acrylic copolymer to rosin is comprised between 0.2:1 and 1.5:1.

7. The process according to claim 6, wherein the ratio of acrylic copolymer to rosin is comprised between 0.5:1 and 1.2:1.

8. The process according to claim 1, wherein the divalent metal source is selected from the group consisting of compounds of calcium, zinc, magnesium and combinations thereof.

9. The process according to claim 8, wherein the divalent metal source is selected from the group consisting of calcium oxide, calcium hydroxide, calcium acetate, zinc oxide, zinc hydroxide, magnesium oxide and combinations thereof.

10. The process according to claim 9, wherein the divalent metal source consist of mixture of zinc oxide in a ratio to rosin of 0.01:1 to 0.1:1 and calcium acetate in a ratio to rosin of 0.005:1 to 0.1:1.

11. The process according to claim 3, wherein the polyol is selected from the group consisting of glycerol, pentaerythritol, trimethylolethane, trimethylolpropane, neopentyl glycol, cyclohexanedimethanol and mixtures thereof.

12. The process according to claim 3, wherein the ratio of polyol to rosin is comprised between 0.02:1 and 0.5:1.

13. The process according to claim 1, comprising the steps of:
a) melting rosin, heating with agitation at a temperature of 200° C. and then adding an acrylic copolymer having methyl methacrylate and styrene in a ratio to rosin of 0.429:1;
b) heating the previous mixture at 250° C., then adding zinc oxide in a ratio to rosin of 0.062:1, calcium acetate in a ratio to rosin of 0.024:1 and allowing the mixture to react at a temperature of 250° C. until a transparent resin is obtained; and
c) adding glycerol in a ratio to rosin of 0, 114:1 and allowing to react at a temperature of 250° C., until a constant viscosity is obtained which corresponds to a minimum flow time of 9 sin the DIN 6 cup.

14. A rosin resin obtained by the process according to claim 1, characterized by:
a) a flow time of a solution at 30% of solids in toluene, in DIN 6 cup, at a temperature of 22° C., between 9 sand 40 s; and,
b) a dilution rate of at least 150%, corresponding to the addition of at least 172 mL of toluene to 100 g of resin solution at 30% of solids in toluene, to obtain a flow time of 30 sin GS 3 mm cup at a temperature of 22° C.

15. Use of the resin according to claim 13, wherein the resin is applied as binder in the preparation of inks.
